(19) United States
(12) Patent Application Publication
(10) Pub. No.: US 2017/0168810 A1
(43) Pub. Date: Jun. 15, 2017

(54) TECHNIQUE FOR UPDATING SOFTWARE ON BOARD AN AIRCRAFT

(71) Applicant: Airbus Operations GmbH, Hamburg (DE)

(72) Inventors: Thorsten KNIJNENBURG, Hamburg (DE); Ilja WAIGL, Hamburg (DE)

(21) Appl. No.: 15/375,496

(22) Filed: Dec. 12, 2016

(30) Foreign Application Priority Data
Dec. 11, 2015 (DE) 102015224950.6

(51) Int. Cl. G06F 9/445; H04L 12/24; H04L 29/08

(52) U.S. Cl. CPC G06F 8/65; H04L 67/10; H04L 41/20; H04L 67/34

(57) ABSTRACT

An interface unit for use in updating software of an aircraft component on board an aircraft. The interface unit comprises a first interface to connect to a server providing one or more software updates for upload to the aircraft component, and a second interface to connect to the aircraft component. The interface unit further comprises a receiving component configured to receive a software update from the server via the first interface for upload to the aircraft component, and an uploading component configured to upload the received software update to the aircraft component via the second interface.

### CROSS-REFERENCES TO RELATED APPLICATIONS

This application claims the benefit of the German patent application No. 10 2015 224 950.6 filed on Dec. 11, 2015, the entire disclosures of which are incorporated herein by way of reference.

### BACKGROUND OF THE INVENTION

The present disclosure generally relates to updating software on board an aircraft. More particularly, the present disclosure relates to an interface unit for use in updating software of an aircraft component on board an aircraft, to a system and a method for updating software of an aircraft component on board an aircraft, as well as to a computer program for executing the method.

Over the recent decades, the amount of software used in aircraft systems and equipment on board an aircraft has steadily grown. Software management has thus become increasingly challenging and techniques have been developed that particularly address the aspect of updating software of aircraft components, for example, for maintenance purposes or for applying advanced configurations to the components.

Today, more and more components on board an aircraft support centralized in-field software loading to ease the software updating process. In in-field software loading, so called Field Loadable Software (FLS) is loaded onto the aircraft component and used to update its software. Loading FLS into aircraft components typically takes place while the component is installed on the aircraft and, therefore, FLS is referred to as software that can be loaded without removing the component from its installation in the aircraft. Generally, FLS is aircraft level software that is identified, controlled and distributed as Loadable Software Aircraft Parts (LSAP). Each such unit of software may have a unique part number that represents its function and version, which may be controlled in a similar way to that of aircraft hardware parts, using an authority document such as an Illustrated Parts Catalogue (IPC), for example. Loading FLS into aircraft components may be performed in accordance with data loading communication protocols set out in commonly used ARINC standards.

In-field software loading generally allows for more efficient maintenance procedures, because it avoids the need to ship the aircraft component to a shop, such as a factory of the component manufacturer, in order to have the component's software updated. Rather than de-installing the aircraft component, shipping it to a shop for maintenance and re-installing it after shop data loading, software can be distributed and loaded directly in the aircraft, for example from a central server. In-field software loading also allows for fewer error-prone maintenance procedures, because software updates are usually held within the central server which is capable of performing version control. Software incompatibilities originating from wrongly uploaded software versions—as it may happen in the case of external shop loading—may thus be avoided.

Typically, however, not all components of today's aircraft support in-field software loading, either because today's aircraft still make use of legacy components or because they make use of state-of-the-art components which are not yet designed for in-field software loading. As an example, the Doors and Slides Management System (DSMS) of the Airbus A380 comprises up to 18 software-based components which are not in-field software loadable. For these components, software updates need to be uploaded manually one by one in case of software modifications. The above-described advantages of in-field software loading are not available for these components and there is still a requirement for removal from the aircraft and shipment to a service shop for maintenance purposes.

### SUMMARY OF THE INVENTION

It is thus an object of the present disclosure to provide a technique that eases software updates for non in-field software loadable aircraft components.

According to a first aspect, an interface unit for use in updating software of an aircraft component on board an aircraft is provided. The interface unit comprises a first interface for connectivity to a server providing one or more software updates for upload to the aircraft component, and a second interface for connectivity to the aircraft component. The interface unit further comprises a receiving component configured to receive a software update from the server via the first interface for upload to the aircraft component, and an uploading component configured to upload the received software update to the aircraft component via the second interface.

The interface unit may thus act as an interface between the aircraft component and the server that allows the server to upload software updates to the aircraft component when the server and the aircraft component do not support interfaces themselves which allow them to communicate which each other directly. As explained above, this may be the case for non in-field software loadable aircraft components since these components may have a dedicated interface that is usable for shop software loading only. The interface unit may, in other words, be used to extend the functionality of non in-field software loadable aircraft components by an in-field software loading capability. In this way, the maintenance effort for performing software updates to aircraft components that are not in-field software loadable may be drastically reduced since these components do no longer have to be de-installed from the aircraft and shipped to a shop for receiving software updates.

Aircraft components referred to herein may comprise any system, device or equipment of an aircraft (or any component or subcomponent thereof) which is software-based, i.e., which comprises software to perform its functions. This may include, for example, flight controls, engine controls, navigational systems, communication systems, flight management systems, traffic collision avoidance systems, cabin management systems, power supply systems, or the like. Aircraft components may come in the form of Line Replaceable Units (LRU).

For connectivity purposes, the first interface may support the same communication standard that is supported by the server and the second interface may support the same communication standard that is supported by the aircraft component and normally used during shop maintenance. The first interface and the second interface may thus be communication interfaces each of which supports a different communication standard, e.g., they may support different communication technologies (e.g., on the physical layer), they may have different connection terminals or ports and/or they may support different communication protocols (e.g., on lower and/or higher layers in the protocol stack). In other words, the first interface and the second interface may be interfaces of different types.

In one variant, the first interface may be a wireless communication interface. An example of a wireless communication interface may be a Wireless Local Area Network (WLAN) network interface which allows for communication with the server via a WLAN connection. The WLAN may be an in-flight WLAN provided on board the aircraft. Optionally, the WLAN connection may be a secured WLAN connection. Using wireless connectivity between the interface unit and the server saves wiring and avoids impacting the aircraft wiring installation when software maintenance is performed.

The second interface, on the other hand, may be a wire-based communication interface. Since many aircraft components support serial communication over serial ports, the second interface may, in one variant, be a serial interface supporting, for example, the RS-232 standard and may comprise a serial port, for example, a RS-232 serial port. The second interface may be connected to the aircraft component using a cable, for example a serial cable, connected between the second interface and an interface of the aircraft component which is normally used for shop maintenance.

The software update may be provided in the form of Field Loadable Software (FLS). The software update may be received from the server by the receiving component of the interface unit using a first data loading communication protocol, wherein the first data loading communication protocol may be a data loading communication protocol set out by an ARINC standard. Similarly, the software update may be uploaded to the aircraft component by the uploading component of the interface unit using a second data loading communication protocol, wherein the second data loading communication protocol may be a data loading communication protocols set out by an ARINC standard as well.

In one variant, the first data loading communication protocol and the second data loading communication protocol may be the same. The server may thus use the same data loading communication protocol which is supported by the aircraft component and which is normally used for shop maintenance. In another variant, the first data loading communication protocol and the second data loading communication protocol may be different. The server may thus use a different data loading communication protocol than that which is supported by the aircraft component and which is normally used for shop maintenance. In this case, the interface unit may receive the software update using the first data loading communication protocol from the server and may upload the software update using the second data loading communication protocol to the aircraft component. In both variants, the interface unit may be said to forward the software update from the server to the aircraft component.

In one implementation, the interface unit may be a portable standalone device. The interface unit may have a lightweight form, for example the form of a small box, that allows service personnel to easily carry the device and connect it to an aircraft component wherever needed in the aircraft. As a standalone device, the interface unit may have an integrated power supply unit which may be supplied, for example, via an external power cord or via a rechargeable battery.

In another implementation, the interface unit may take the form of a piggy-back module that is coupled to the aircraft component. As a piggy-back module, the interface unit may be permanently attached to the aircraft component and its power supply unit may obtain power supply from the aircraft component itself, for example.

In any implementation, the interface unit may comprise at least one processor and at least one memory, wherein the at least one memory may contain instructions executable by the at least one processor such that the interface unit is operable to perform the functions described herein. The receiving component and the uploading component of the interface unit may be implemented as software components that are stored in the at least one memory, for example. It will be understood, however, that the receiving component and the uploading component of the interface unit may alternatively be implemented as hardware circuitry.

According to a second aspect, a system for updating software of one or more aircraft components on board an aircraft is provided. The system comprises a server providing one or more software updates for upload to the one or more aircraft components, and one or more interface units of the first aspect each being connected to the server via its first interface and each being connected to one of the one or more aircraft components via its second interface.

All aspects described above with reference to the interface unit, the server and the aircraft component are applicable to the system of the second aspect as well. Unnecessary repetitions are thus omitted in the following.

In one variant, the server may be a central server computer installed in the aircraft and, in another variant, the server may be a portable computer, such as a laptop that may be carried by service personnel during a maintenance procedure. In both variants, the server may host a central software repository that stores software updates for one or more aircraft components on board the aircraft and provides them for upload to the aircraft components accordingly. In case of a needed software modification, the server may trigger a corresponding software upload to one or more aircraft components, wherein upload transmission is directed via the corresponding interface units.

In case the system comprises a plurality of interface units, the server may update a plurality of aircraft components in one run. In one such case, the server may be configured to transmit—simultaneously (e.g., in parallel) or in sequence—the same software update to a plurality of interface units for upload to the corresponding plurality of aircraft components. In another such case, the server may be configured to transmit—simultaneously (e.g., in parallel) or in sequence—a plurality of different software updates to a plurality of interface units, one each, for upload to the corresponding plurality of aircraft components. In these cases, software updates to aircraft components can be applied in a highly efficient manner since a plurality of aircraft components can be updated in a single run automated and directed under control of the server.

According to a third aspect, a method for updating software of an aircraft component on board an aircraft is provided. The method is performed by an interface unit comprising a first interface for connectivity to a server providing one or more software updates for upload to the aircraft component, and a second interface for connectivity to the aircraft component. The method comprises receiving a software update from the server via the first interface for upload to the aircraft component, and uploading the software update to the aircraft component via the second interface.

The method may be performed by an interface unit according to the first aspect. All apparatus features described herein with reference to the first aspect may thus also be embodied as functions, services or steps in the method of the third aspect.

According to a fourth aspect, a computer program product is provided. The computer program product comprises program code portions for performing the method of the third aspect when the computer program product is executed on one or more computing devices. The one or more computing devices may comprise the interface unit according to the first aspect. The computer program product may be stored on a computer readable recording medium, such as a semiconductor memory, DVD, CD-ROM, or the like.

All of the aspects described herein may be implemented by hardware circuitry and/or by software. Even if some of the aspects are described herein with respect to the interface unit or the system, these aspects may also be implemented as a method or as a computer program for performing or executing the method. Likewise, aspects described as or with reference to a method may be realized by suitable components in the interface unit or in the system, or by means of the computer program.

### BRIEF DESCRIPTION OF THE DRAWINGS

In the following, the present disclosure will further be described with reference to exemplary implementations illustrated in the figures, in which:

FIG. 1 schematically illustrates a composition of an interface unit and a transmission path of a software update from a server to an aircraft component via the interface unit; and

FIG. 2 schematically illustrates a flowchart of a method which may be performed by the interface unit of FIG. 1.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other implementations that depart from the specific details. Those skilled in the art will further appreciate that functions explained herein below may be implemented using individual hardware circuitry, using software functioning in conjunction with a programmed microprocessor or a general purpose computer, using an application specific integrated circuit (ASIC) and/or using one or more digital signal processors (DSPs). It will also be appreciated that when the present disclosure is described as a method, it may also be embodied in a device (e.g., the interface unit described herein below), a computer processor and a memory coupled to a processor, wherein the memory is encoded with one or more programs that perform the methods disclosed herein when executed by the processor.

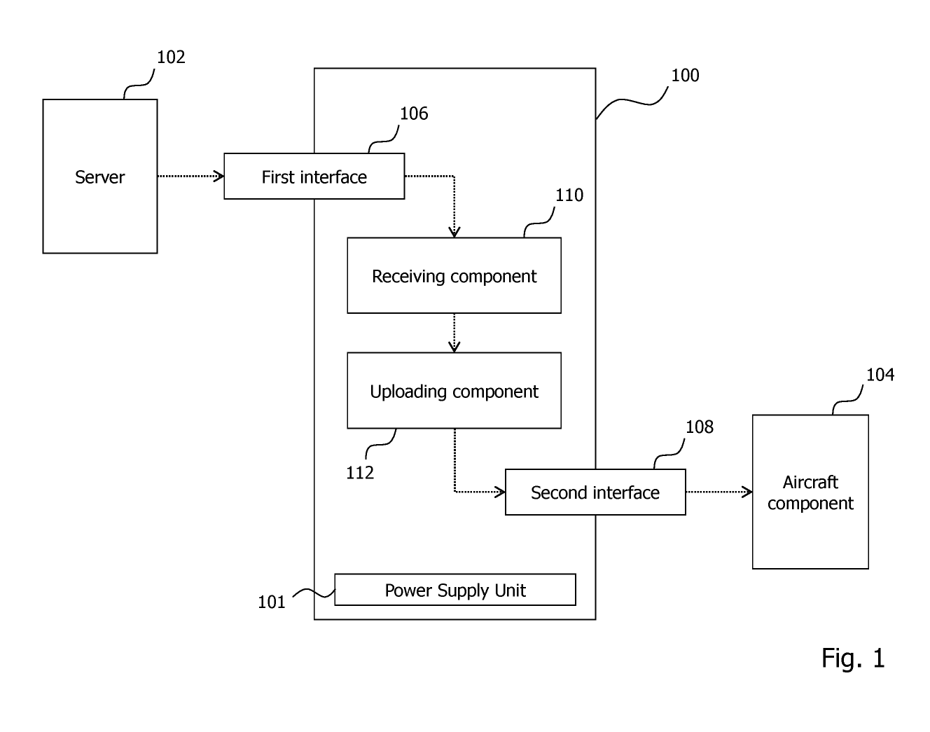

FIG. 1 schematically illustrates an exemplary composition of an interface unit 100 and a transmission path of a software update uploaded from a server 102 to an aircraft component 104 via the interface unit 100.

The interface unit 100 may be a portable standalone device which may be provided in a lightweight form, for example in the form of a small box, that allows service personnel to easily carry the device and connect it to the aircraft component 104. As a standalone device, the interface unit 100 may have an integrated power supply unit 101 which may be supplied, for example, via an external power cord or via a rechargeable battery. Alternatively, the interface unit 100 may take the form of a piggy-back module which is permanently coupled to the aircraft component 104, in which case the power supply unit 101 of the interface unit 100 may obtain power supply from the aircraft component 104 itself, e.g., via a corresponding electrical connection between the aircraft component 104 and the power supply unit 101.

The server 102 may be a central server computer installed in the aircraft or may be a portable computer, such as a laptop, that may be carried by service personnel during a maintenance procedure. The server 102 may host a central software repository that stores one or more software updates for one or more aircraft components 104 and provides the software updates for upload to the aircraft components 104. The server 102 may trigger, in case of a needed software modification, a corresponding software upload to the aircraft component 104.

The aircraft component 104 may be any system, device or equipment of an aircraft (or any component or subcomponent thereof) which is software-based, i.e., which comprises software to perform its functions. This may include, for example, flight controls, engine controls, navigational systems, communication systems, flight management systems, traffic collision avoidance systems, cabin management systems, power supply systems, or the like. The aircraft component 104 may come in the form of a Line Replaceable Unit (LRU).

As shown in FIG. 1, the interface unit 100 comprises a first interface 106, a second interface 108, a receiving component 110 and an uploading component 112.

The interface unit 100 is connected to the server 102 via the first interface 106. The first interface 106 is a communication interface that supports the same communication standard that is supported by the server 102. In one preferred example, the first interface 106 is a wireless communication interface, for example, a Wireless Local Area Network (WLAN) network interface which allows for communication with the server 102 via a WLAN connection. The WLAN may be an in-flight WLAN provided on board the aircraft and, optionally, the WLAN connection may be a secured WLAN connection. It will be understood that, in other examples, the first interface 106 may be any other kind of communication interface, for example, a wire-based communication interface or a wireless communication interface supporting another wireless communication standard.

The interface unit 100 is connected to the aircraft component 104 via the second interface 108. The second interface 108 is a communication interface that supports the same communication standard that is supported by the aircraft component 104 and that is normally used in shop maintenance. In one preferred example, the second interface 108 is a wire-based communication interface, for example, a serial interface supporting the RS-232 standard and comprising a RS-232 serial port. The connection between the second interface 108 and the aircraft component 104 may be established using a serial cable plugged into respective serial ports provided at the second interface 108 and at an interface of the aircraft component 104 normally used for shop maintenance. It will be understood that, in other examples, the second interface 108 may be any other kind of communication interface, for example, another wire-based communication interface supporting another wire-based communication standard.

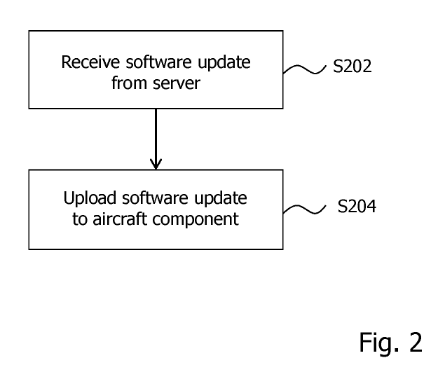

When the server 102 triggers a software upload to the aircraft component 104, a software update is transmitted from the server 102 to the aircraft component 104 via the interface unit 100. As shown in FIG. 2, which schematically illustrates a flowchart of a method performed by the interface unit 100, the software update is received, in step S202, by the receiving component 110 of the interface unit 100 via the first interface 106. The software update is then uploaded, in step S204, to the aircraft component 104 by the uploading component 112 of the interface unit 100 via the second interface 108.

The software update may be provided in the form of Field Loadable Software (FLS) and may be received from the server 102 using a first data loading communication protocol, which may be a data loading communication protocol set out by an ARINC standard. The software update may then be uploaded to the aircraft component 104 using a second data loading communication protocol, which may be a data loading communication protocol set out by an ARINC standard as well. The first and the second data loading communication protocol may be the same in case the server 102 supports the data loading communication protocol which is supported by the aircraft component 104 and normally used for shop maintenance. The first and the second data loading communication protocol may be different in case the server 102 does not support the data loading communication protocol which is supported by the aircraft component 104 and normally used for shop maintenance. In both cases, the interface unit 100 may be said to forward the software update from the server 102 to the aircraft component 104.

As has become apparent from the above description, the interface unit 100 may act as an interface between the aircraft component 104 and the server 102 that allows the server 102 to upload software updates to the aircraft component 104 when the server 102 and the aircraft component 104 do not support interfaces themselves which allow them to communicate which each other in a direct manner As explained above, this may be the case for non in-field software loadable aircraft components since these components may have a dedicated interface that is usable for shop maintenance only. By the use of the interface unit 100, therefore, the maintenance effort for performing software updates to non in-field software loadable aircraft components can be reduced since these components do no longer have to be de-installed from the aircraft and shipped to a shop for receiving respective updates.

In the example of FIG. 1, a system is shown where the server 102 provides software updates for upload to only one aircraft component 104 via only one interface unit 100. It will be understood that, in other examples of such a system, the server 102 may provide software updates for upload to a plurality of aircraft components 104. In this case, each aircraft component 104 may be assigned a dedicated interface unit 100 so that all aircraft components 104 may be updated by the server 102 in a single run. For example, the server 102 may upload—simultaneously (e.g., in parallel) or in sequence—the same software update to a plurality of aircraft components 104 via respective interface units 100. In another example, the server 102 may upload—simultaneously (e.g., in parallel) or in sequence—a plurality of different software updates to a plurality of aircraft components 104 via respective interface units 100, wherein each aircraft component 104 receives a different software update. In such systems, software updates can be applied in a highly efficient manner since a plurality of aircraft components 104 can be updated in a single run automated and directed under control of the server 102.

It is believed that the advantages of the technique presented herein will be fully understood from the foregoing description, and it will be apparent that various changes may be made in the form, constructions and arrangement of the exemplary aspects thereof without departing from the scope of the disclosure or without sacrificing all of its advantageous effects. Because the technique presented herein can be varied in many ways, it will be recognized that the disclosure should be limited only by the scope of the claims that follow.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An interface unit for use in updating software of an aircraft component on board an aircraft, the interface unit comprising:
a first interface for connectivity to a server providing one or more software updates for upload to the aircraft component,
a second interface for connectivity to the aircraft component,
a receiving component configured to receive a software update from the server via the first interface for upload to the aircraft component, and
an uploading component configured to upload the received software update to the aircraft component via the second interface.

2. The interface unit of claim 1, wherein the first interface and the second interface are communication interfaces, each supporting a different communication standard.

3. The interface unit of claim 1, wherein the first interface is a wireless communication interface.

4. The interface unit of claim 1, wherein the second interface is a wire-based communication interface.

5. The interface unit of claim 1, wherein the software update is provided in the form of Field Loadable Software.

6. The interface unit of claim 1, wherein the interface unit is a portable standalone device.

7. The interface unit of claim 1, wherein the interface unit is a piggy-back module coupled to the aircraft component.

8. The interface unit of claim 1, wherein the interface unit comprises an integrated power supply unit.

9. A system for updating software of one or more aircraft components on board an aircraft, the system comprising:
a server providing one or more software updates for upload to the one or more aircraft components; and
one or more interface units according to claim 1 each being connected to the server via its first interface and each being connected to one of the one or more aircraft components via its second interface.

10. The system of claim 9, wherein the server is a central server computer installed in the aircraft.

11. The system of claim 9, wherein the server is a portable computer.

12. A method for updating software of an aircraft component on board an aircraft, the method being performed by an interface unit comprising a first interface for connectivity to a server providing one or more software updates for upload to the aircraft component, and a second interface for connectivity to the aircraft component, the method comprising:
receiving a software update from the server via the first interface for upload to the aircraft component; and
uploading the received software update to the aircraft component via the second interface.

13. A computer program product stored on a non-transitory medium comprising executable instructions for causing the interface unit to carry out the method of claim 12 when the computer program product is executed on one or more computing devices.

14. A non-transitory computer readable recording medium storing a computer program product according to claim 13.

15. An interface unit comprising the non-transitory computer readable recording medium according to claim 14.
